(19) United States
(12) Patent Application Publication
(10) Pub. No.: US 2011/0123643 A1
(43) Pub. Date: May 26, 2011

(54) COPPER ALLOY ENCLOSURES

(76) Inventors: Robert A. Biersteker, Hilbert, WI (US); John J. Stevens, Sherwood, WI (US); Carl J. Michalewski, Appleton, WI (US); Robert F. Cyra, Wrightstown, WI (US)

(21) Appl. No.: 12/625,359

(22) Filed: Nov. 24, 2009

(51) Int. Cl. A01N 59/16; C22C 9/02; B32B 15/04; B32B 15/02; A01K 69/08

(52) U.S. Cl. 424/641; 420/470; 420/473; 428/450; 428/605; 43/100

(57) ABSTRACT

An antifouling barrier comprising a silicon bronze alloy, the silicon bronze alloy comprising about 0.5% to about 3.8% silicon (wt/wt alloy) and greater than about 90% copper (wt/wt alloy). In some embodiments, the silicon bronze alloy additionally comprises from about 0.05% to about 1.3% manganese (wt/wt alloy). The antifouling barrier may be a welded wire mesh, screen, chain-link, chain-mail, grid, weave, perforated sheet, or chicken wire. Methods of reducing the growth of an organism on an animal enclosure, comprising contacting at least a portion of the animal enclosure with an antifouling barrier comprising a silicon bronze alloy comprising about 0.5% to about 3.8% silicon (wt/wt alloy) and greater than about 90% copper (wt/wt alloy).

### FIELD OF THE INVENTION

The present application relates to materials and methods for the prevention of biofouling, or the undesired accumulation of one or more organisms on a surface. Marine biofouling is commonplace in lakes, seas, oceans, bays, ponds, reservoirs, estuaries and rivers. Marine biofouling may involve any of a wide variety of organisms, including animals, plants, and microorganisms, such as, but not limited to, algae, seaweeds, anemones, and barnacles. Biofouling is most widespread in warmer waters with low velocity water and high nutrient content. However, biofouling can be problematic in cooler waters as well as nutrient-poor waters. Biofouling is detrimental to marine surfaces because it increases drag and weight, weakens the underlying materials, and, in some cases, harbors toxins, microorganisms, and viruses.

Biofouling has become a particular concern to commercial fisheries, especially those fisheries that rely on enclosures such as fish pens, lobster traps, and crab traps, which are exposed to seawater for long periods of time. In some cases the biofouling is merely a nuisance, requiring the traps to be cleaned regularly to prevent the build-up of algaes and slime, which degrade the materials. In other case, biofouling encourages the growth of organisms such as barnacles and algae on the harvested animals, resulting in a less-appealing products that fetch a lower market price. In still other cases, biofouling can provide a breeding ground for harboring and transmitting bacteria or viruses that kill the harvested animals, or make the harvested animals toxic to humans.

Enclosures that diminish biofouling may also pose a risk to the animals that are restrained within the enclosures, however. For example, high-copper content alloys that have innate antimicrobial properties have been shown to be effective at diminishing biofouling in marine environments. See, e.g., Huguenin, “The Advantages and Limitations of Using Copper Materials in Marine Aquaculture,” IEEE Ocean '75, p. 444-453 (1975), incorporated herein by reference in its entirety. However, these same alloys may kill or sicken the animals within. Shellfish and mollusks, such as lobsters, crabs, crayfish, oysters, scallops, clams, and mussels, are especially susceptible to harm from copper poisoning when placed in enclosures constructed from alloys having high copper content.

### SUMMARY OF THE INVENTION

The invention provides, among other things, a welded wire mesh of a silicon bronze alloy comprising about 0.5% to about 3.8% silicon (wt/wt alloy) and greater than about 90% copper (wt/wt alloy). In some embodiments, the silicon bronze alloy additionally includes from about 0.05% to about 1.3% manganese (wt/wt alloy). The silicon bronze may additionally comprise a naturally-occurring silicon oxide coating. An enclosure may be constructed from the welded wire mesh of the invention.

The invention additionally provides, among other things, a method of restraining a marine animal with reduced biofouling, comprising restraining the marine animal in an enclosure comprising a welded wire mesh of a silicon bronze alloy, the silicon bronze alloy comprising about 0.5% to about 3.8% silicon (wt/wt alloy) and greater than about 90% copper (wt/wt alloy). In some embodiments, the silicon bronze alloy additionally includes from about 0.05% to about 1.3% manganese (wt/wt alloy). The silicon bronze may additionally comprise a naturally-occurring silicon oxide coating. The marine animal may be a lobster, a crab, a crayfish, a shrimp, an oyster, a clam, a scallop, an eel, or a fish.

The invention additionally provides, among other things, an antifouling barrier comprising a silicon bronze alloy including about 0.5% to about 3.8% silicon (wt/wt alloy) and greater than about 90% copper (wt/wt alloy). In some embodiments, the silicon bronze alloy additionally includes from about 0.05% to about 1.3% manganese (wt/wt alloy). The silicon bronze may further comprise a naturally-occurring silicon oxide coating. The antifouling barrier may be, but is not limited to, a screen, chain-link, chain-mail, grid, weave, perforated sheet, or chicken wire. Animal enclosures, comprising the barrier of the invention, may be constructed. Such enclosures include, but need not be limited to, nets, pens, traps, kennels, buckets, boxes, stalls, trays, and paddocks.

The invention additionally provides, among other things, a method of reducing the growth of an organism on an animal enclosure, comprising contacting at least a portion of the animal enclosure with an antifouling barrier comprising a silicon bronze alloy comprising about 0.5% to about 3.8% silicon (wt/wt alloy) and greater than about 90% copper (wt/wt alloy). In some embodiments, the silicon bronze alloy may additionally comprise from about 0.05% to about 1.3% manganese (wt/wt alloy). The organism whose growth is reduced may be an animal, a plant, or a microorganism. In some embodiments, the growth of Staphylococcus epidermidis, Escherichia coli, Navicula incerta, Cellulophaga lytica, Halomonas pacifica, Pseudoalteromonas atlantica, Cobetia marina, Clostridium difficile, or Listeria monocytogenes may be reduced. In some embodiments, the growth of infectious salmon anemia virus (ISAV), viral hemorrhagic septicemia (VHS), epizootic hematopoietic necrosis virus (EHNV), infectious hematopoietic necrosis virus (IHNV), or koi herpes virus may be reduced.

The invention additionally provides, among other things, a method for reducing the growth of an organism on a structure, comprising contacting at least a portion of the structure with an antifouling barrier comprising a silicon bronze alloy comprising about 0.5% to about 3.8% silicon (wt/wt alloy) and greater than about 90% copper (wt/wt alloy). In some embodiments, the silicon bronze alloy may additionally comprise from about 0.05% to about 1.3% manganese (wt/wt alloy). The silicon bronze may further comprise a naturally-occurring silicon oxide coating. The structure may be an offshore platform, a seawall, a piling, a pier, a wharf, a dock, or a buoy.

Other aspects of the invention will become apparent by consideration of the detailed description and accompanying drawings.

### BRIEF DESCRIPTION OF THE DRAWINGS

FIG. 1 shows an embodiment of a barrier comprising a silicon bronze alloy.

FIG. 2 shows another embodiment of a barrier comprising a silicon bronze alloy.

FIG. 3 shows another embodiment of a barrier comprising a silicon bronze alloy.

FIG. 4 shows a lobster trap comprising a silicon bronze alloy netting.

FIG. 5 shows a crab trap comprising a silicon bronze alloy weave.

FIG. 6 shows a fish pen comprising a silicon bronze alloy weave.

### DETAILED DESCRIPTION

The invention provides copper alloys that are effective in reducing the growth of organisms that contact, or grow on, the alloys. Silicon bronze alloys, typically having about 0.5% to about 3.8% silicon (wt/wt alloy) and greater than about 90% copper (wt/wt alloy), are suitable for reducing the growth of organisms, especially animals, plants, and microorganisms. The silicon bronze alloys may additionally comprise about 0.05% to about 1.3% manganese (wt/wt alloy), as well as up to 1.5% zinc, up to 0.8% iron, 0.8% lead, and 0.6% nickel. In many embodiments, the lead will be present in only trace amounts (less than 0.05%). Some embodiments will comprise about 2.0% silicon, about 1.0% manganese, about 1.0% zinc, and about 96% copper.

High-copper content alloys have been touted for their antibacterial activity, and the U.S. EPA has recently certified several copper alloys as public health antimicrobial products. (See http://www.epa.gov/pesticides/factsheets/copper-alloy-products.htm) While the exact reasons for the antibacterial activity of high copper-content alloys are unknown, it is suspected that the predominantly copper surfaces disrupt the outer membrane or cell wall of an organism that contacts the alloy. When the cellular architecture is disrupted, the cytoplasm is compromised, in many cases resulting in the death of the cell. Consequently, it is difficult for biofilms or colonies of microorganisms to populate the high copper-content alloys.

Copper alloys having appreciable silicon content (i.e., silicon bronzes) are known to produce a protective silicon oxide layer upon exposure to water, and it was believed that the silicon oxide layer would limit the effectiveness of silicon bronze alloys as anti-fouling barriers. Recent testing has shown that silicon bronze alloys do maintain their antibacterial properties upon exposure to water, however. The mechanism is unknown, but it is hypothesized that the silicon oxide coating is semi-permeable to copper atoms within the allow. More surprisingly, silicon bronzes have been found to be generally effective antifouling agents, reducing the growth of a wide variety of organisms, including animals, plants, and microorganisms. In particular, silicon bronze alloys are effective antifouling agents when used in marine environments.

As discussed above, antifouling alloys can pose a risk to animals that are exposed to the alloys. Surprisingly, silicon bronze alloys, such as those described in the invention, do not appear to affect the health of animals restrained within an enclosure made from the silicon bronze, however. This property makes silicon bronze alloys of the invention suitable for constructing enclosures for shellfish and mollusks, among other animals. Additionally, the mechanical properties of the silicon bronze alloys facilitates the fabrication of barriers such as welded-wire mesh, screen, chain-link, chain-mail, grid, weave, or chicken wire. The silicon bronze alloys are also strong and stiff while exhibiting good cold-worked and hot-formed workability. Thus it is possible to make entire enclosures, including, but not limited to, nets, pens, traps, kennels, buckets, boxes, stalls, trays, and paddocks from silicon bronze alloys.

Other copper alloys may exhibit antifouling properties while not harming an animal restrained in an enclosure constructed from the copper alloy. These alloys may include tin bronzes having 1-8% (wt/wt) tin content and 0.3% to 0.35% (wt/wt) phosphorus content, and aluminum bronzes having 4-9% (wt/wt) aluminum content.

As used herein, animals include any species from the kingdoms Animalia or Metazoa. Animals may include, but need not be limited to, crustaceans, such as barnacles and sea lice, slugs, and anemone. Animals may also includes insects, such as fleas, and lice, as well as arachnids, such as ticks. As used herein, plants includes any species from the kingdom Plantae. Plants may include, but need not be limited to seaweeds, algae, mosses, and kelp. As used herein, microorganisms includes single-cell and multi-cell bacteria, fungi, parasites, protozoans, archaea, protests, amoeba, viruses, diatoms, and algae. Microorganisms whose growth may be inhibited by silicon bronze alloys of the invention include, but are not limited to, Staphylococcus aureus, Staphylococcus epidermidis, Streptococcus faecalis, Bacillus subtilis, Salmonella chloraesius, Salmonella typhosa, Escherichia coli, Mycobacterium tuberculosis, Pseudomonas aeruginosa, Aerobacter aerogenes Saccharomyces cerevisiae, Candida albicans, Aspergillus niger, Aspergillus flares, Aspergillus terreus, Aspergillus verrucaria, Aureobasidium pullulans, Chaetomium globosum, Penicillum funiculosum, Trichophyton interdigital, Pullularia pullulans, Trichoderm sp. madison P-42, and Cephaldascus fragans; Chrysophyta, Oscillatoria bometi, Anabaena cylindrical, Selenastrum gracile, Pleurococcus sp., Gonium sp., Volvox sp., Klebsiella pneumoniae, Pseudomonas fluorescens, Proteus mirabilis, Enterobacteriaceae, Acinetobacter spp., Pseudomonas spp., Candida spp., Candida tropicalis, Streptococcus salivarius, Rothia dentocariosa, Micrococcus luteus, Sarcina lutea, Salmonella typhimurium, Serratia marcescens, Candida utilis, Hansenula anomala, Kluyveromyces marxianus, Listeria monocytogenes, Serratia liquefasciens, Micrococcus lysodeikticus, Alicyclobacillus acidoterrestris, MRSA, Bacillus megaterium, Desulfovibrio sulfuricans, Streptococcus mutans, Cobetia marina, Enterobacter aerogenes, Enterobacter cloacae, Proteus vulgaris, Proteus mirabilis, Lactobacillus plantarum, Halomonas pacifica, Ulva linza, and Clostridium difficile. Additionally, silicon bronze alloys of the invention my inhibit the growth of viruses such as infectious salmon anemia virus (ISAV), viral hemorrhagic septicemia (VHS), epizootic hematopoietic necrosis virus (EHNV), infectious hematopoietic necrosis virus (IHNV), koi herpes virus, or avian flu virus. Silicon bronze alloys of the invention may reduce the growth of small colonies of microorganisms, in addition to reducing the growth of biofilms.

The biocidal properties of the silicon bronze alloys of the invention lend themselves to the fabrication and installation of barriers made from the silicon bronze alloys. The barriers may protect nearly any structure that would otherwise be at risk for the growth of organisms on the structure. Marine structures include, but need not be limited to, offshore platforms, seawalls, pilings, piers, wharfs, docks, or buoys. Other structures suitable for protection with a silicon bronze alloy of the invention can be found throughout the globe, including but not limited to structures within hospitals, homes, factories, laboratories, food processing facilities, farms, dairies, subways, airports, and bathrooms. For example, silicon bronze alloys of the invention may be used to reduce the growth of organisms on knobs, handles, rails, poles, countertops, sinks, faucets, urinals, dispensers, pots, pans, and utensils.

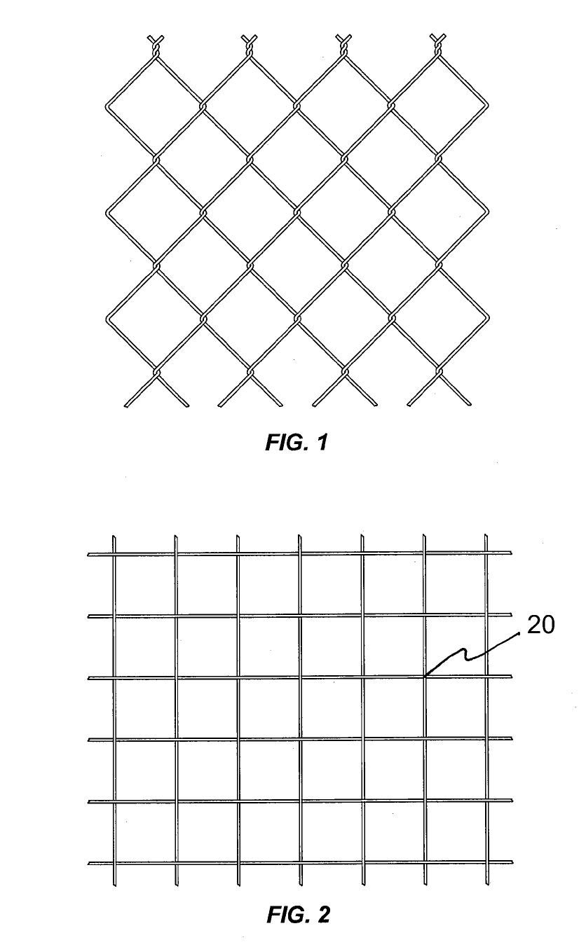

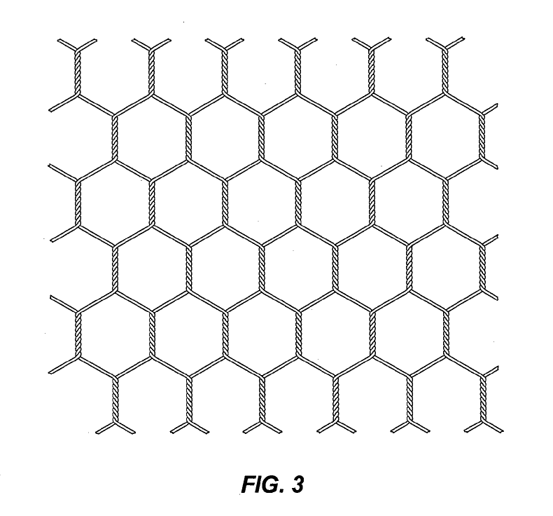

Barriers formed from silicon bronze alloys of the invention may be of any suitable shape depending upon the mechanical needs (e.g., strength, flow-through, weight, etc.) of the associated structure. Barriers of the invention may suitably be formed from sheets, strips, wires, plates, rods, bars, ingots, or tubes of the alloy. The barriers may be formed using any suitable mechanical process including, but not limited to, rolling, welding, drawing, twisting, extruding, machining, lathing, stamping, pulling, or cutting. The final barrier may be a welded-wire mesh, sheet, tube, screen, chain-link, chain-mail, grid, weave, perforated sheet, or chicken wire, however other structures would be within the purview of one of skill in the art. As shown in FIG. 1, silicon bronze alloy wire may be formed into a chain link, which, depending upon the gauge of the wire, will have some amount of flexibility. As shown in FIG. 2, silicon bronze alloy wire may be formed into a mesh or weave, which may have a varying amount of open space between the wires, depending upon the end application. In some embodiments, intersections 20 between wires may be mechanically fixed, e.g., with welding, lashing, or fasteners. The arrangement shown in FIG. 2 with welded intersections 20 may be described as a welded-wire mesh. Intersections 20 may be resistively welded, oxyacetylene welded, arc welded, soldered, or brazed. In other embodiments, the woven wires are capable of freely moving past one another. As shown in FIG. 3, silicon bronze alloy wire may also be formed into a repeating hexagonal structure, also known as chicken wire. Other open barrier structures may also be used, including chain mail or ring mail.

Different barrier structures offer differing degrees of rigidity in the ultimate barrier. For example a weave of thicker wire may be directly bent or formed to form structures such as a box, a trap or a pen. In contrast, flexible materials, such as mails may be useful as netting. In some embodiments, more rigid barrier materials may not need additional structural support, however, in other embodiments less rigid barriers may need additional support, e.g., a frame. The overall resistance to corrosion of the barrier may depend upon the physical structure and use, however, as repeated abrasion may remove the protective silicon oxide layer, allowing for corrosion of the underlying alloy. Typically, copper alloys fabricated into relatively inflexible forms such as expanded metal and welded mesh can withstand repetitive motions over a prolonged time better than flexible forms, such as chain link or woven mesh.

In addition to barriers formed from the silicon bronze alloys, antifouling protection may be provided by coatings comprising silicon bronze alloys of the inventions. Such coatings may be coated onto metal, rock, cement, plastic, glass, or ceramic to reduce the growth of organisms on those surfaces. The coatings may be applied with electrospray. Antifouling protection may also be provided by incorporating microscopic or nanoscopic particles of silicon bronze alloys into plastics, glasses, paints or fabrics.

The silicon bronze barriers of the invention may be used to construct a variety of animal enclosures, including, but not limited to, nets, pens, traps, kennels, buckets, trays, boxes, stalls, and paddocks. Animals suitable to be placed in the enclosures include any wild or domesticated animal that may be captured, harvested, raised, or bred for human benefit. (In the case of traps, the animals place themselves in the enclosures.) Once the animals are placed or trapped in the enclosures, the animals are considered to be restrained. Animals suitable to be placed in enclosures include, but need not be limited to fish, eels, lobsters, crab, shrimp, crawfish, mussels, clams, oysters, scallops, rabbits, chickens, turkeys, ferrets, guinea pigs, hamsters, mice, rats, cows, horses, pigs, goats, sheep, deer, dogs, cats, and birds.

Because of the biocidal activity of the silicon bronze barriers of the invention, animal enclosures comprising silicon bronze barriers offer increased resistance to biofouling, including the growth of animals, plants, or microorganisms on the enclosure. Biofouling is known to increase the risk of disease transmission, especially from bacteria and viruses, and may result in harvested or domesticated animals that are sick, unproductive, or unappealing. For example, the prevalence of infectious salmon anemia virus (ISAV) in farmed Atlantic salmon has been linked to biofouling of fish pens. ISAV is characterized by high mortality with exophthalmia, pale gills, ascites, hemorrhagic liver necrosis, renal interstitial hemorrhage and tubular nephritis. ISAV is known to cause overt and fatal systemic infection in farmed Atlantic salmon and asymptomatic infection in feral fish, a situation analogous to that caused by avian influenza viruses in domestic poultry and feral birds. Once a fish pen has been exposed to an ISAV outbreak, it may be necessary to destroy or sanitize the fish pen to avoid spreading the virus to subsequent populations of fish. Using the silicon bronze alloys of the invention, however, a fish farmer experiencing an outbreak of ISAV need only remove the infected stock from the pen and restock the pen to resume farming.

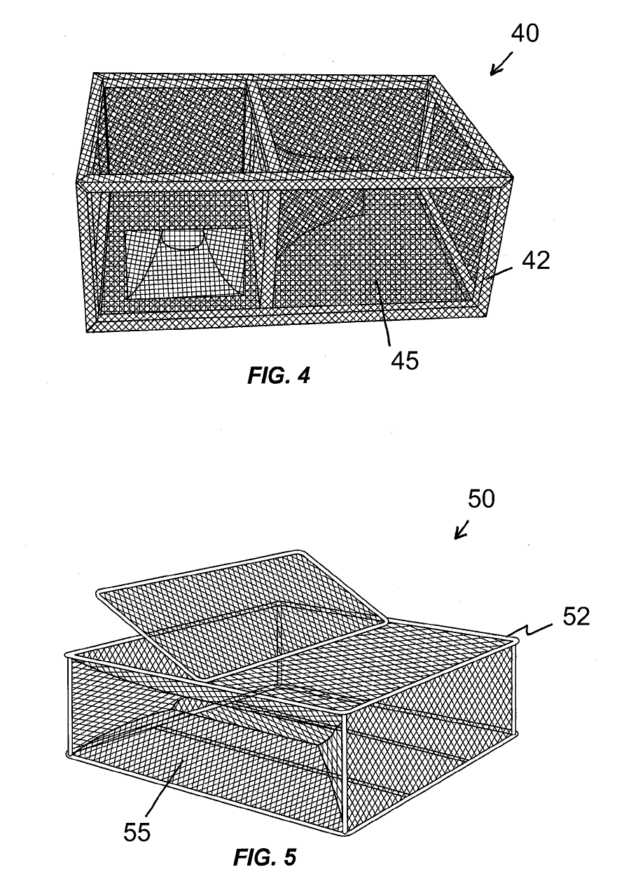

The combination of biocidal activity and corrosion resistance will make silicon bronze alloys of the invention excellent materials for the construction of marine enclosures such as fish pens and traps. As shown in FIG. 4, lobster trap 40 may be constructed of silicon bronze frame 42 and silicon bronze mesh 45. Mechanically, lobster trap 40 is identical to lobster traps known in the industry, and will be equally effective in trapping lobsters. The use of silicon bronze alloys results in lobster trap 40 having less biofouling and superior corrosion resistance to other traps known in the industry, however. While not shown, suitable lobster traps can also be constructed from welded wire mesh of copper alloys. As shown in FIG. 5, crab trap 50 may be constructed of silicon bronze frame 52 and silicon bronze mesh 55. Mechanically, crab trap 50 is identical to crab traps known in the industry, and will be equally effective in trapping crabs. The use of silicon bronze alloys results in crab trap 50 having less biofouling and superior corrosion resistance to other traps known in the industry, however.

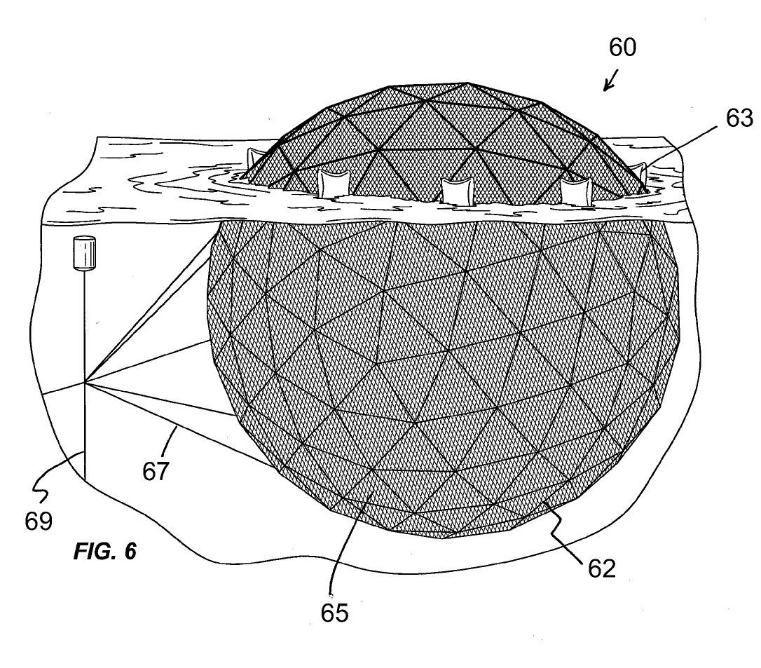

Silicon bronze alloys may also be used to construct any of a number of enclosures for farmed fish. In one embodiment, illustrated in FIG. 6, a fish pen is made in the shape of a geodesic dome. Geodesic fish pen 60 may be constructed from polyethylene supports 62, which provide a rigid structure and some buoyancy. (Additional buoyancy may be provided by floats 63 as needed). The fish are retained within geodesic fish pen 60 by silicon bronze ring mail 65 which serves the dual purpose of keeping the farmed fish in and keeping predators (e.g., sharks) out. Geodesic fish pen 60 is tethered with lines 67 to anchor 69, which is connected to a weight on the seabed (not shown). Geodesic fish pen 60 is particularly well suited for cultivation of larger ocean-borne fish.

The copper alloys of the invention additionally provide a method for reducing the growth of an organism on a structure, comprising contacting at least a portion of the structure with an antifouling barrier comprising a silicon bronze alloy comprising about 0.5% to about 3.8% silicon (wt/wt alloy) and greater than about 90% copper (wt/wt alloy). In some embodiments, the silicon bronze alloy comprises about 2.0% to about 3.5% silicon (wt/wt alloy). In some embodiments, the silicon bronze alloy additionally comprises from about 0.05% to about 1.3% manganese (wt/wt alloy). In some embodiments, the silicon bronze alloy composition is (wt/wt alloy): 0.5-3.8% silicon; 0.05-1.3% manganese; maximum 1.5% zinc; maximum 0.8% iron; maximum 0.8% lead; maximum 0.6% nickel; and balance copper. In some embodiments, the silicon bronze alloy additionally comprises a silicon-oxide coating. When used to reduce the growth of an organism on a structure, the alloys are effective in reducing the growth of organisms such as barnacles, algae, seaweed, and kelp. Structures suitable for having the growth of organisms reduced include offshore platforms, seawalls, pilings, piers, wharfs, docks, and buoys.

It is to be understood that the invention is not limited in its application to the details of construction and the arrangement of components set forth in the following description. The invention is capable of other embodiments and of being practiced or of being carried out in various ways. Also it is to be understood that the phraseology and terminology used herein is for the purpose of description and should not be regarded as limiting.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any nonclaimed element as essential to the practice of the invention.

It also is understood that any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

Further, no admission is made that any reference, including any patent or patent document, cited in this specification constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinency of any of the documents cited herein.

### PROPHETIC EXAMPLES

### Example 1

### Silicon Bronze Wire Weave

Silicon bronze alloy wire having a diameter of 4 mm, and having the following composition will be obtained from a commercial source (Luvata Appleton, LLC, Kimberly, Wis.).

Composition of silicon bronze alloy.

| Element | % composition (wt/wt alloy) |
|---|---|
| Silicon | 3.0 |
| Manganese | 1.0 |
| Copper | Balance |

(The silicon bronze alloy may have trace amounts of lead, iron, zinc, and nickel.) The 4 mm wire will be fabricated into a mesh similar to FIG. 2, with spot welding at the junctions of the wire.

The silicon bronze wire weave will be submerged in Atlantic Ocean water off the coast of Massachusetts for three months, with weekly observation to quantify (observable) corrosion and biofouling. As a control, a 4 mm welded galvanized steel mesh, and a 4 mm welded 90/10 copper/nickel alloy mesh also will be submerged in nearby water, and observed on the same schedule. The weaves will not be cleaned until the end of the trial.

Within weeks of placement in the water, both the 90/10 copper/nickel alloy and galvanized materials will have developed a thin coating of algae. The silicon bronze alloy, however, will not develop an algae coating until about one month into the trial. With time, the galvanized sample will grow a thick coating of algae with stingy attachments. The 90/10 copper nickel alloy will stabilize after about one month, but will consistently have more algae than the silicon bronze alloy.

After three months, the weaves will be removed from the ocean and cleaned with high-pressure fresh water. The degree of corrosion will then be quantified. The silicon bronze formulation will show a build-up of a silicon oxide layer, resulting in a material that is duller in luster than the original alloy, but otherwise, there will be no other outward sign of corrosion. Similar to the silicon bronze alloy, the 90/10 copper/nickel alloy will have less luster, but will not show appreciable corrosion. The galvanized steel weave, however, will show discoloration and pitting across the surface and of the metal, as well as rust at the junctions of the wire.

### Example 2

### Crab Pens of Welded Wire Silicon Bronze Alloy and 90/10 Copper Nickel Alloy

Two 30 cm×100 cm×100 cm crab pens will be fabricated. Pen 1 will be fabricated from welded wire silicon bronze alloy using the alloy of EXAMPLE 1. Pen 2 will be fabricated from a 90/10 copper nickel alloy with welding. Both pens will have 1.5 cm spacing between wires, and be of identical construction save the alloy composition. Five Lake Pontchartrain Blue Crabs (Callinectes sapidus) will be placed in each pen, and the pens will be placed in approximately 2 meters of water in Lake Pontchartrain (Louisiana, U.S.A.) for two months for observation. The crabs will be able to feed on their normal diet. After about three weeks, the crabs in Pen 2 (90/10 copper nickel) will begin to die, with all of the crabs in Pen 2 dead by week five. All five crabs in Pen 1 (silicon bronze alloy) will be alive and healthy at the end of the two month trial, and at least one of the crabs will have molted.

### Example 3

### Lobster Trap with Silicon Bronze Wire Weave

Five standard Atlantic Lobster wire-type traps, will be purchased from a commercial trap supplier (e.g., Rainbow Net Rigging, Ltd., Dartmouth, Nova Scotia) and the polyvinyl-coated steel mesh will be replaced with silicon bronze wire mesh from EXAMPLE 1. The test traps will have identically sized kitchens and parlors and use the same bait bags. The traps will be placed in service with 200 standard polyvinyl-coated steel weave lobster traps from the same manufacturer. After two months of service, the silicon bronze traps will be notably less fouled than the polyvinyl-coated steel weave traps. Additionally, the lobsters harvested from the silicon bronze traps will have fewer shell blemishes and appear healthier upon harvest.

### Example 4

### Crab Trap with Silicon Bronze Wire Weave

Ten standard Alaskan King crab traps, similar to FIG. 4, will be purchased from a commercial trap supplier (e.g., Dungeness Gear Works, Everitt, Wash.) and the polyvinyl-coated steel chain-link will be replaced with silicon bronze chain-link formed from the alloy of EXAMPLE 1. The traps will be placed in service with 500 standard polyvinyl-coated steel weave crab traps from the same manufacturer. After a season of service, the silicon bronze traps will be notably less fouled than the polyvinyl-coated steel weave traps. Additionally, the crabs harvested from the silicon bronze traps will have fewer shell blemishes and appear healthier upon harvest.

### Example 5

### Fish Pen with Silicon Bronze Chain Mail

A geodesic dome fish pen, similar to FIG. 6, will be constructed using a silicon bronze chain mail having the same composition as the silicon bronze weave of EXAMPLE 1. The geodesic fish pen will have a frame constructed of reinforced polyethylene, and the silicon bronze chain mail will be fastened to the frame using silicon bronze wire. The completed pen will have a volumetric capacity of 1000 cubic meters.

The pen will be anchored in approximately 50 feet of water in a protected bay in Hawaii, U.S.A. The pen will have approximately 2000 small mahi mahi (Coryphaena hippurus) placed inside the pen. The fish will be regularly fed hydraulically from a feed boat via a hose linkage, allowing for the transfer of water-borne squid and smaller fish. After eight months, the mahi-mahi will be harvested by removing the pen from the ocean. Upon removal, there will be little biofouling of the silicon bronze chain mail, and the fish will be healthy and marketable.

### Example 6

### Survival Rates for Clostridium difficile on Silicon Bronze Surface

A 10 mm×10 mm sample of the alloy of EXAMPLE 1 (“sample”) will be cut from 3 mm thick sheet stock. The sample will be degreased and cleaned by vortexing the sample in acetone along with 2 mm glass beads and then immersing the sample in 200 proof ethanol. Prior to testing, excess ethanol will be burned off with a Bunsen burner. As a control, a 10 mm×10 mm piece of 3 mm thick stainless steel (“control”) will also be degreased and immersed in ethanol, and the excess ethanol burned off.

Clostridium difficile on glycerol protected beads (Fisher Scientific) will be incubated anaerobically with brain heart infusion broth (Oxoid) at 37° C. for 3-5 days to produce a culture of vegetative cells and spores for testing. Both the control and sample will have 20 μL of the Clostridium difficile culture pipetted onto their respective surfaces, and the control and sample will be incubated at room temperature for 2 hours. After two hours of incubation, 20 μL of a 5 mM solution of CTC (5-Cyano-2,3-ditolyl tetrazolium chloride; Sigma-Aldrich) will be deposited on the sample and the control, and the sample and control will be incubated in a dark, humid chamber for at 37° C. for 8 hours.

After rinsing the sample and control with sterile DI water to remove excess CTC stain, the sample and control will be imaged using epifluorescent microscopy, and a series of field views will be collected with a digital camera. A count of cells or spores in these field views will show that after two hours of incubation, the control sample had a great number of metabolically active cells or spore (e.g., CTC-stained) while the sample had less than 1% of the metabolically active cells or spores that were found on the control. The data will thus confirm that the alloy of EXAMPLE 1 kills at least 99% of Clostridium difficile within two hours.

### Example 7

### Survival Rates for Listeria monocytogenes on Silicon Bronze Surface

As in EXAMPLE 4, a 10 mm×10 mm sample of the alloy of EXAMPLE 1 (“sample”) will be cut from 3 mm thick sheet stock. The sample will be degreased and cleaned by vortexing the sample in acetone along with 2 mm glass beads and then immersing the sample in 200 proof ethanol. Prior to testing, excess ethanol will be burned off with a Bunsen burner. As a control, a 10 mm×10 mm piece of 3 mm thick stainless steel (“control”) will also be degreased and immersed in ethanol, and the excess ethanol burned off.

Listeria monocytogenes Scott A from previously frozen microbeads (Centre for Applied Microbiology Research, Porton Down, UK) will be incubated with brain heart infusion broth (Oxoid) at 37° C. for 15-20 hours to produce an active culture for testing. Both the control and sample will have 20 μL of the Listeria monocytogenes culture pipetted onto their respective surfaces, and the control and sample will be incubated at room temperature for 2 hours. After two hours of incubation, 20 μL of a 5 mM solution of CTC (5-Cyano-2,3-ditolyl tetrazolium chloride; Sigma-Aldrich) will be deposited on the sample and the control, and the sample and control will be incubated in a dark, humid chamber for at 37° C. for 2 hours.

After rinsing the sample and control with sterile DI water to remove excess CTC stain, the sample and control will be imaged using epifluorescent microscopy, and a series of field views will be collected with a digital camera. A count of cells or in these field views will show that after two hours of incubation, the control sample had a great number of metabolically active cells (e.g., CTC-stained) while the sample had less than 1% of the metabolically active cells that were found on the control. The data will thus confirm that the alloy of EXAMPLE 1 kills at least 99% of Listeria monocytogenes within two hours.

Thus, the invention provides, among other things, barriers comprising silicon bronze alloys and animal enclosures incorporating the barriers. Various features and advantages of the invention are set forth in the following claims.

What is claimed is:

1. A welded wire mesh of a silicon bronze alloy comprising about 0.5% to about 3.8% silicon (wt/wt alloy) and greater than about 90% copper (wt/wt alloy).

2. The welded wire mesh of claim 1, wherein the silicon bronze alloy comprises about 2.0% to about 3.5% silicon (wt/wt alloy).

3. The welded wire mesh of claim 1, wherein the silicon bronze alloy additionally comprises from about 0.05% to about 1.3% manganese (wt/wt alloy).

4. The welded wire mesh of claim 3, wherein the silicon bronze alloy composition is (wt/wt alloy):
0.5-3.8% silicon;
0.05-1.3% manganese;
maximum 1.5% zinc;
maximum 0.8% iron;
maximum 0.8% lead;
maximum 0.6% nickel; and
balance copper.

5. The welded wire mesh of claim 1, wherein the silicon bronze alloy additionally comprises a silicon-oxide coating.

6. An enclosure comprising the welded wire mesh of claim 1.

7. The enclosure of claim 6, wherein the enclosure is lobster trap, a crab trap, a crayfish trap, a shrimp cage, an oyster cage, a scallop tray, a clam tray, an eel cage, or a fish pen.

8. A method of restraining a marine animal with reduced biofouling, comprising restraining the marine animal in an enclosure comprising a welded wire mesh of a silicon bronze alloy, the silicon bronze alloy comprising about 0.5% to about 3.8% silicon (wt/wt alloy) and greater than about 90% copper (wt/wt alloy).

9. The method of restraining a marine animal with reduced biofouling of claim 8, wherein the silicon bronze alloy comprises about 2.0% to about 3.5% silicon (wt/wt alloy).

10. The method of restraining a marine animal with reduced biofouling of claim 8, wherein the silicon bronze alloy additionally comprises from about 0.05% to about 1.3% manganese (wt/wt alloy).

11. The method of restraining a marine animal with reduced biofouling of claim 10, wherein the silicon bronze alloy composition is (wt/wt alloy):
0.5-3.8% silicon;
0.05-1.3% manganese;
maximum 1.5% zinc;
maximum 0.8% iron;
maximum 0.8% lead;
maximum 0.6% nickel; and
balance copper.

12. The method of restraining a marine animal with reduced biofouling of claim 8, wherein the silicon bronze alloy additionally comprises a silicon-oxide coating.

13. The method of restraining a marine animal with reduced biofouling of claim 8, wherein the marine animal is a lobster, a crab, a crayfish, a shrimp, an oyster, a clam, a scallop, an eel, or a fish.

14. An antifouling barrier comprising a silicon bronze alloy, the silicon bronze alloy comprising about 0.5% to about 3.8% silicon (wt/wt alloy) and greater than about 90% copper (wt/wt alloy).

15. The antifouling barrier of claim 14, wherein the silicon bronze alloy comprises about 2.0% to about 3.5% silicon (wt/wt alloy).

16. The antifouling barrier of claim 14, wherein the silicon bronze alloy additionally comprises from about 0.05% to about 1.3% manganese (wt/wt alloy).

17. The antifouling barrier of claim 16, wherein the silicon bronze alloy composition is (wt/wt alloy):
0.5-3.8% silicon;
0.05-1.3% manganese;
maximum 1.5% zinc;
maximum 0.8% iron;
maximum 0.8% lead;
maximum 0.6% nickel; and
balance copper.

18. The antifouling barrier of claim 14, wherein the silicon bronze alloy additionally comprises a silicon-oxide coating.

19. The antifouling barrier of claim 14, wherein the barrier is a screen, chain-link, chain-mail, grid, weave, or chicken wire.

20. The antifouling barrier of claim 14, wherein the barrier is a coating.

21. An animal enclosure comprising the antifouling barrier of claim 14.

22. The animal enclosure of claim 21, wherein the enclosure is a net, pen, trap, kennel, bucket, box, stall, tray, or paddock.

23. The animal enclosure of claim 22, wherein the enclosure is a lobster trap or a crab trap.

24. The animal enclosure of claim 22, wherein the enclosure is a fish pen.

25. A method of reducing the growth of an organism on an animal enclosure, comprising contacting at least a portion of the animal enclosure with an antifouling barrier comprising a silicon bronze alloy comprising about 0.5% to about 3.8% silicon (wt/wt alloy) and greater than about 90% copper (wt/wt alloy).

26. The method of reducing the growth of an organism on an animal enclosure of claim 25, wherein the silicon bronze alloy comprises about 2.0% to about 3.5% silicon (wt/wt alloy).

27. The method of reducing the growth of an organism on an animal enclosure of claim 25, wherein the silicon bronze alloy additionally comprises from about 0.05% to about 1.3% manganese (wt/wt alloy).

28. The method of reducing the growth of an organism on an animal enclosure of claim 27, wherein the silicon bronze alloy composition is (wt/wt alloy):
0.5-3.8% silicon;
0.05-1.3% manganese;
maximum 1.5% zinc;
maximum 0.8% iron;
maximum 0.8% lead;
maximum 0.6% nickel; and
balance copper.

29. The method of reducing the growth of an organism on an animal enclosure of claim 25, wherein the silicon bronze alloy additionally comprises a silicon-oxide coating.

30. The method of reducing the growth of an organism on an animal enclosure of claim 25, wherein the barrier is a screen, chain-link, chain-mail, grid, weave, or chicken wire.

31. The method of reducing the growth of an organism on an animal enclosure of claim 25, wherein the organism is an animal, a plant, or a microorganism.

32. The method of reducing the growth of an organism on an animal enclosure of claim 31, wherein the animal is a barnacle or a lice.

33. The method of reducing the growth of an organism on an animal enclosure of claim 31, wherein the plant is an algae, a seaweed or a kelp.

34. The method of reducing the growth of an organism on an animal enclosure of claim 31, wherein the microorganism is Staphylococcus epidermidis, Escherichia coli, Navicula incerta, Cellulophaga lytica, Halomonas pacifica, Pseudoalteromonas atlantica, Cobetia marina, Clostridium difficile, or Listeria monocytogenes.

35. The method of reducing the growth of an organism on an animal enclosure of claim 31, wherein the microorganism is infectious salmon anemia virus (ISAV), viral hemorrhagic septicemia (VHS), epizootic hematopoietic necrosis virus (EHNV), infectious hematopoietic necrosis virus (IHNV), or koi herpes virus.
